(19) United States
(12) Patent Application Publication
(10) Pub. No.: US 2026/0155138 A1
(43) Pub. Date: Jun. 4, 2026

(54) OPTIMIZING SPEECH-TO-TEXT DATASETS

(71) Applicant: Hirundo LTD, Binyamina-Givat Ada (IL)

(72) Inventor: Tomer RAVIV, Ramat Gan (IL)

(73) Assignee: Hirundo LTD, Binyamina-Givat Ada (IL)

(21) Appl. No.: 19/403,092

(22) Filed: Nov. 27, 2025

Related U.S. Application Data
(60) Provisional application No. 63/727,238, filed on Dec. 3, 2024.
(60) Provisional application No. 63/734,790, filed on Dec. 17, 2024.

(51) Int. Cl. G10L 15/06; G10L 15/16

(52) U.S. Cl. CPC G10L 15/063; G10L 15/16

(57) ABSTRACT

There is provided a computer-implemented, comprising: accessing a baseline training dataset of audio samples, each labelled with a text transcript, training a first model on the baseline training dataset to learn a data distribution and patterns to generate a trained first model with a parameter vector, computing, for each token in each text transcript, a self-influence score by a self-influence function that measures an alignment of each token with the patterns encoded in the parameter vector, selecting a subset of audio samples having self-influence scores meeting a requirement indicating mislabeling, removing the subset of audio samples and corresponding transcripts from the baseline training dataset, or correcting the text transcripts for each audio sample of the subset, to generate an adapted training dataset, and providing the adapted training dataset for training a second model on the adapted STT training dataset or for unlearning the subset from the trained first model.

### RELATED APPLICATIONS

This application claims the benefit of priority under 35 USC § 119(e) of U.S. Provisional Patent Application No. 63/734,790 filed on Dec. 17, 2024, and of U.S. Provisional Patent Application No. 63/727,238 filed on Dec. 3, 2024, the contents of which are all incorporated by reference as if fully set forth herein in their entirety.

### BACKGROUND

The present invention, in some embodiments thereof, relates to training datasets for machine learning models and, more specifically, but not exclusively, to optimizing training datasets for training a speech-to-text machine learning model.

Machine learning, and deep learning in particular, has experienced unprecedented growth and success over the past decade. This success can be largely attributed to advances in computational power, the availability of large-scale datasets, and the maturation of training algorithms. As a result, deep neural networks have become highly effective at learning complex mappings from input data to desired outputs, solving a diverse range of tasks once considered intractable. These tasks span from object recognition and identification in images and videos, to natural language processing activities such as text summarization and generation, and even complex decision-making scenarios involving dynamic and uncertain environments.

Speech-to-Text (STT), also known as automatic speech recognition (ASR), is the process by which spoken language is converted into its written form. At its core, STT systems take raw audio signals—captured from human voices in various environments, languages, and accents—and translate them into structured text. This capability has profound implications worldwide: it allows for hands-free interaction with devices, and enables more natural and accessible user interfaces for smartphones, computers, and emerging IoT platforms. STT also empowers people with hearing impairments or language barriers to communicate and access information more easily, promotes inclusivity in digital services, and aids in transcribing large volumes of spoken content (such as news broadcasts or podcasts) for better searchability and analysis. As global reliance on voice-driven technologies grows, speech-to-text plays an increasingly critical role in bridging the gap between human communication and digital systems.

### SUMMARY

According to a first aspect, a computer-implemented method for generating an adapted speech-to-text (STT) training dataset for training a STT model, comprises: accessing a baseline STT training dataset comprising a plurality of audio samples, each audio sample labelled with a text transcript, training a first STT model on the baseline STT training dataset to learn a data distribution and patterns of the baseline STT training dataset to generate a trained first STT model with a parameter vector, computing, for each token in each text transcript of the baseline training dataset, a self-influence score by a self-influence function that measures an alignment of each token with the patterns encoded in the parameter vector, selecting a subset of audio samples of the baseline STT training dataset having self-influence scores meeting a requirement indicating audio samples that are likely mislabeled, removing the subset of audio samples and corresponding transcripts from the baseline STT training dataset, or correcting the text transcripts for each audio sample of the subset, to generate an adapted STT training dataset, and providing the adapted STT training dataset for training a second STT model on the adapted STT training dataset or for unlearning the subset from the trained first STT model.

According to a second aspect, a computer-implemented method for generating an adapted speech-to-text (STT) training dataset for training a STT model, comprising: accessing a baseline STT training dataset comprising a plurality of audio samples, each audio sample labelled with a text transcript, training a first STT model on the baseline STT training dataset to learn a data distribution and patterns of the baseline STT training dataset to generate a trained first STT model with a parameter vector, computing, for each token in each text transcript of the baseline training dataset, a self-influence score by a self-influence function that measures an alignment of each token with the patterns encoded in the parameter vector, computing a suspect score per text transcript by aggregating over a plurality of self-influence scores computed for a plurality of tokens of an audio sample corresponding to the text transcript, selecting a subset of audio samples of the baseline STT training dataset having suspect scores meeting a requirement indicating audio samples that are likely mislabeled, removing the subset of audio samples and corresponding transcripts from the baseline STT training dataset, or correcting the text transcripts for each audio sample of the subset, to generate an adapted STT training dataset, and providing the adapted STT training dataset for training a second STT model on the adapted STT training dataset or for unlearning the subset from the trained first STT model.

According to a third aspect, a computer-implemented method for generating an adapted speech-to-text (STT) training dataset for training a STT model, comprising: accessing a baseline STT training dataset comprising a plurality of audio samples, each audio sample labelled with a text transcript, training a first STT model on the baseline STT training dataset to learn a data distribution and patterns of the baseline STT training dataset to generate a trained first STT model with a parameter vector, computing, for each token in each text transcript of the baseline training dataset, a self-influence score by a self-influence function that measures an alignment of each token with the patterns encoded in the parameter vector, selecting a subset of audio samples of the baseline STT training dataset having self-influence scores meeting a requirement indicating audio samples that are likely mislabeled, unlearning the subset of audio samples and corresponding transcripts from the trained first STT model.

In a further implementation form of the first, second, and third aspects, further comprising training the second STT model on the adapted STT training dataset.

In a further implementation form of the first, second, and third aspects, further comprising triggering a process for unlearning the subset of audio samples by the first trained STT model.

In a further implementation form of the first, second, and third aspects, further comprising: generating a graphical user interface (GUI) presented on a display, the GUI presenting each text transcript of the subset and a visual element associated with each text transcript, the GUI configured to play the audio sample corresponding to the text transcript over a speaker in response to interaction with the visual element, the GUI configured for enabling a user to manually adapt each text transcript of the subset.

In a further implementation form of the first, second, and third aspects, the selecting is based on self-influence scores computed for individual tokens within the text transcripts, wherein the subset of audio samples selected from the baseline STT training dataset correspond to individual tokens of the plurality of text transcripts.

In a further implementation form of the first, second, and third aspects, further comprising computing a suspect score per text transcript by aggregating over a plurality of self-influence scores computed for a plurality of tokens of the text transcript corresponding to the audio sample, wherein the subset of audio samples is selected from the baseline STT training dataset based on the suspect scores that are derived from the self-influence scores of corresponding text transcripts of the plurality of tokens.

In a further implementation form of the first, second, and third aspects, the aggregating is selected from a group consisting of: summation of the plurality of self-influence scores over the plurality of tokens of the text transcript, averaging of the plurality of self-influence scores over the plurality of tokens of the text transcript, and selecting a maximum self-influence score among the plurality of self-influence scores computed for the plurality of tokens of the text transcript.

In a further implementation form of the first, second, and third aspects, further comprising ranking the audio samples of the baseline STT training dataset according to corresponding self-influence scores from highest to lowest, and the requirement denotes a predefined number of highest or lowest ranked audio samples likely being mislabeled.

In a further implementation form of the first, second, and third aspects, the trained first STT model generates a sequence of tokens one by one, with each subsequent token being conditioned on an input audio sample and at least one previously generated token, wherein the parameter vector and previously generated tokens are provided as an input to the trained first STT model in association with the input audio sample.

In a further implementation form of the first, second, and third aspects, initial weights of the first STT model prior to training on the baseline STT training dataset are computed by pre-training on a corpus of data or randomized.

In a further implementation form of the first, second, and third aspects, the first STT model and the second STT model are implemented as neural networks, wherein the parameter vector includes the weights of the neurons of the trained neural network.

In a further implementation form of the first, second, and third aspects, the self-influence function is selected from the group consisting of: an upweighting loss-based influence function that evaluates gradients of a loss function with respect to model parameters and incorporates a Hessian matrix to estimate parameter sensitivity, and a TracIn influence function comprising a gradient-based trace function that computes sums of dot products of gradients of training and test data loss functions across a plurality of training checkpoints.

In a further implementation form of the first, second, and third aspects, the requirement is selected from a group consisting of: a fixed absolute number of audio samples, a relative proportion of a number of the plurality of audio samples in the baseline STT training dataset, and a knee-point analysis identifying an inflection point in a plot of self-influence scores arranged in descending order.

In a further implementation form of the first, second, and third aspects, the self-influence score is computed for a STT test dataset different from the baseline STT training dataset, wherein a distribution of the STT test dataset is statistically similar to a distribution of the baseline STT training dataset, wherein the subset is selected from the STT test dataset, and wherein the adapted STT training dataset is created from the STT test dataset serving as a second STT training dataset.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of an exemplary system for identifying anomalous text transcripts of audio samples, in accordance with some embodiments of the present invention;

FIG. 2 is a flowchart of an exemplary method for identifying anomalous text transcripts of audio samples, in accordance with some embodiments of the present invention;

FIG. 3 is a flowchart of another exemplary method for identifying potentially mislabeled audio samples, in accordance with some embodiments of the present invention;

FIG. 4 is a flowchart of yet another exemplary method for identifying potentially mislabeled audio samples, in accordance with some embodiments of the present invention.

### DETAILED DESCRIPTION

The present invention, in some embodiments thereof, relates to training datasets for machine learning models and, more specifically, but not exclusively, to optimizing training datasets for training a speech-to-text machine learning model.

As used herein, the term STT model is used to refer to a speech to text (STT) machine learning (ML) model.

As used herein, the term record may be used to refer to an audio sample and corresponding text transcript. The record is included in a STT training dataset for training the STT ML model. It is noted that multiple records may be generated from a single audio sample, where each record includes the same audio sample, and a different token from a sequence of tokens of the text transcript.

An aspect of some embodiments of the present invention relates to systems, methods, computing devices, and/or code instructions (stored on a data storage device and executable by one or more processors) for identifying anomalies in a STT training dataset, for example, an incorrect text transcript associated with an audio sample, missing text transcript for the audio sample, and/or other error. The anomalies in the STT training dataset reduce performance of the STT model trained on the STT training dataset, for example, the STT model learns an erroneous mapping between the audio sample and the incorrect text transcript, and/or is penalized when it accurately predicts the correct text transcript due to the incorrect label.

A baseline STT training dataset of audio samples is accessed. Each audio sample is labelled with a text transcript. Each text transcript is formed by multiple tokens. One or more records of the baseline STT training dataset may include anomalies. An STT model is trained on the baseline STT training dataset, to learn a data distribution and/or patterns of the baseline STT training dataset. The STT model trained on the baseline training dataset is referred to herein as a trained STT model. The trained STT model is associated with a parameter vector. In embodiments in which the trained STT model is implemented as a neural network, the parameter vector includes the weights of the neurons of the trained neural network. A self-influence score is computed for each token in each text transcript of the baseline training dataset. The self-influence score is computed by a self-influence function that measures an alignment of each token with the patterns encoded in the parameter vector. Optionally, a suspect score is computed per text transcript by aggregating over multiple self-influence scores computed for multiple tokens of an audio sample corresponding to the text transcript. A subset of audio samples of the baseline STT training dataset that are likely mislabeled, such as with incorrect tokens and/or text transcripts, is identified. The subset is identified as records having self-influence scores and/or suspect scores meeting a requirement, for example, records with highest self-influence scores or lowest self-influence score, depending on the self-influence function that is used (i.e., whether higher self-influence scores indicate more accurate prediction or less accurate prediction). One or more actions may be taken in response to the identified subset. For example:
Removing the subset of audio samples and corresponding transcripts from the baseline STT training dataset, to generate an adapted STT training dataset. Another STT model is trained on the adapted STT training dataset.
Correcting the text transcripts (and/or tokens) for each audio sample of the subset, to generate an adapted STT training dataset. Another STT model is trained on the adapted STT training dataset.
Performing an unlearning process on the trained STT model to unlearn the subset.

At least one embodiment addresses the technical problem of improving quality of a training dataset (i.e., data) for training a speech to text machine learning model. At least one embodiment improves the technology of machine learning, by improving quality of a training dataset (i.e., data) for training a speech to text machine learning model. At least one embodiment improves upon prior approaches of improving quality of a training dataset (i.e., data) for training a speech to text machine learning model. At least one embodiment provides the practical approach of generating a higher quality (e.g., more accurate) STT model by training on a training dataset that is optimized using approaches described herein, and/or provides the practical approach of providing an adapted training dataset created by optimizing the baseline training dataset.

Performance of machine learning models is based on three pillars:
Model Architectures: The design of deep neural network architectures, including convolutional neural networks (CNNs), recurrent neural networks (RNNs), transformers, and various specialized architectures, has enabled models to capture intricate patterns and relationships within the data.
Data Quality and Availability: The data used to train these models is of paramount importance. High-quality, diverse, and representative datasets ensure the trained model can generalize effectively beyond the samples it was directly exposed to.
Training Algorithms: The optimization and training procedures, including stochastic gradient descent (SGD) and its variants, loss function design, and regularization techniques, help models generalize to new and unseen data distributions.

While all three pillars are significant, embodiments described herein address the second pillar: the data itself. Data is the foundation by which machine learning models are built and refined. Regardless of the complexity or novelty of the model architecture, its ultimate effectiveness heavily depends on the quality and suitability of the dataset it is trained on.

In particular, embodiments described herein are directed towards improving a training dataset for training a model to perform a speech-to-text task. STT datasets have unique characteristics, different from other conventional datasets for other types of data such as images for detection and/or classification of objects, or text for classification. STT dataset may include pairs of raw audio files and corresponding respective transcripts. In STT datasets, the pairing may be temporal—i.e., the audio label corresponds to a specific temporal window in the audio file. In contrast, object detection is spatial, a region within an image is labelled by a bounding box.

At least one embodiment described herein utilizes the self-influence function to identify anomalies at the token level of a transcript corresponding to an audio sample are different than implementations of detecting classification errors generated by a classifier an image. An image is associated with a single label. For example, an image of a cat is associated with a label “cat”. The image may be correctly labelled “cat” or may be incorrectly labelled, for example, as “dog”. In contrast, text transcripts of audio labels may not necessarily be “wrong” but may include one or more errors. For example, the phrase “Let's plan to meet next weak” is not incorrect, but has a spelling error, where “weak” should be “week”. At least one embodiment described herein, which is based on computing the self-influence function at the token level enable detecting such anomalies in the text transcript associated with an audio sample. Moreover, at least one embodiment described herein may consider the sequence of tokens of the text transcript. In contrast, image classifiers classify the image with a single classification outcome. Sequences are not applicable.

The following are exemplary guidelines for gathering reliable, maintainable and/or scalable STT datasets:
Data Collection and Curation: Collecting a large and diverse dataset that accurately represents the target domain or application. In STT scenarios, for example, data may include extensive corpora of audio recordings paired with their corresponding transcripts. These datasets are gathered from various speakers, dialects, acoustic environments, and/or contexts to ensure comprehensive coverage.
Data Storage and Management: Proper storage and management of data-such as in distributed file systems or cloud-based infrastructures-allows for efficient data retrieval, scalability, and versioning. Metadata, annotations, and quality control logs may be maintained in a consistent, accessible manner, ensuring that the data is organized and easily auditable.
Data Annotation and Labeling Tools: After raw data (i.e., audio samples) is collected, it is labeled in a manner that reflects the intended task or objective. For STT, this involves generating accurate transcripts of audio samples. This labeling can be performed manually by trained human annotators, automatically by pre-trained machine learning systems, or through semi-automated pipelines that combine both human and machine efforts. Labeling tools range from web-based annotation platforms that allow humans to listen to and transcribe audio segments, to automated speech recognition models that provide initial transcripts that humans subsequently correct.
Ensuring Data Quality: As the size and complexity of datasets grow, ensuring data quality becomes increasingly challenging. One critical aspect of data quality is minimizing mislabels, which are inaccuracies in the assigned labels of the training examples. Mislabels can arise from human error (e.g., a transcript misstated by a human annotator) or from automated labeling tools that fail to accurately capture nuanced speech elements. Biases in the labeling process-such as annotators consistently misunderstanding certain accents can also degrade model performance and fairness.

The presence of mislabeled examples in training sets can significantly impact a model's performance, as the model may learn incorrect associations or be penalized for correctly interpreting ambiguous samples. These inaccuracies ultimately lead to suboptimal generalization and degraded performance in real-world scenarios.

At least one embodiment is designed to reduce the widespread presence of mislabeled samples within the dataset by leveraging influence functions to pinpoint these inaccuracies and subsequently correct them.

At least one embodiment improves performance of STT models of different architectures and/or trained using different training approaches, by improving the quality of the training data used to train the different STT models.

STT models have rapidly evolved from simple pattern-matching systems to complex architectures that leverage advanced deep learning techniques. Two prominent examples in this space, which may be improved by embodiments described herein, are the Whisper and wav2vec families of models, both of which have multiple variations tailored for different data domains, computational constraints, and accuracy requirements. Although they share a common goal—transcribing spoken language into written text—Whisper and wav2vec take fundamentally different approaches to achieving robust speech recognition.

Whisper, developed by OpenAI, is a weakly supervised model that has been trained on a vast quantity of unlabeled audio and text pairs scraped from the web. Unlike traditional fully supervised settings, where each token or word in the transcription is aligned to specific segments of the audio, Whisper uses paired audio and transcriptions without explicit alignment between them. Whisper doesn't rely on fine-grained time-aligned labels (like forced alignments from tools such as Kaldi or Montreal Forced Aligner). Instead, it uses sequence-level supervision, meaning that the entire transcription is treated as the label for the entire audio, without requiring a detailed mapping between audio frames and tokens. In training, the model learns the alignment implicitly, which is harder than when precise alignments are provided.

Whisper is built of an acoustic encoder, mapping the audio features into latent acoustic features, and a decoder that maps the features into textual tokens. Both encoder and decoder are based on the transformer architecture, with the decoder playing the role of the language model, allowing it to directly map audio inputs into coherent text, complete with punctuation and casing. Whisper's integrated linguistic understanding enables it to handle a broad range of spoken language contexts and dialects without requiring a separate external language model.

By contrast, wav2vec, focuses primarily on the acoustic domain. The core wav2vec model is trained in a self-supervised manner to learn rich audio representations from raw waveforms, capturing subtle nuances in speech signals. During this self-supervised pre-training phase, the model receives unlabeled audio. It then tries to reconstruct masked segments of the audio representation from the surrounding context. This is somewhat analogous to how language models like BERT mask words and learn to predict them based on context, except here it's applied to continuous speech signals instead of text. After pre-training, the model has learned a good general understanding of speech acoustics and structures. At this point, a small labeled dataset containing audio paired with text transcripts may be added. The model can then be fine-tuned on this labeled data so it can map the learned acoustic representations to actual words. This fine-tuning step is where the “labels” (i.e., text transcripts) come into play. Because the model already has strong representations, it can achieve high accuracy even with relatively less labeled data compared to traditional supervised-only approaches.

Moreover, a language model can be integrated on top of the trained wav2vec model. This language model—often a large pre-trained transformer or a specialized language decoder—takes the acoustic tokens generated by wav2vec and produces coherent, grammatical sentences. Wav2vec offers more flexibility due to its modular structure, however it needs to further be combined with a classification head or a language model to output textual tokens.

At least one embodiment provides a targeted and scalable approach to detect mislabeled tokens or sentences in speech-to-text datasets, leveraging self-influence functions to align samples with patterns learned from training data while highlighting anomalies.

At least one embodiment addresses the aforementioned technical problem, and/or improves the aforementioned technology, and/or improves upon the aforementioned prior approaches, and/or provides the aforementioned practical application(s), by computing self-influence scores for text transcripts and/or tokens of the text transcript of the training dataset which are labels of audio sample. Each audio sample may be used to generate multiple records, where in each record the same audio sample is associated with a different token of a sequence of tokens of the text transcript. The self-influence score may be computed on a token-level. The self-influence scores are computed using a self-influence function. The self-influence scores enable identifying text transcripts and/or tokens which may be anomalies, for example, erroneous and/or missing. Identifying anomalies at a token level improves detecting an anomaly in the transcript itself, by enabling detecting anomalies in expected patterns of token in the transcript. For example, identifying minor spelling errors in the transcript, such as “week” versus “weak” based on context of the other tokens in the sequence of tokens of the transcript. The identified errors may be correct or removed, to create a new training dataset for training another STT model, which is predicted to have improved performance in comparison to the baseline STT model trained on the baseline STT training dataset with anomalies.

Embodiments described herein utilize the self-influence function to identify anomalies at the token level of a transcript corresponding to an audio sample are different than implementations of detecting classification errors generated by a classifier an image. An image is associated with a single label. For example, an image of a cat is associated with a label “cat”. The image may be correctly labelled “cat” or may be incorrectly labelled, for example, as “dog”. In contrast, text transcripts of audio labels may not necessarily be “wrong” but may include one or more errors. For example, the phrase “Let's plan to meet next weak” is not incorrect, but has a spelling error, where “weak” should be “week”. Embodiments described herein, which are based on computing the self-influence function at the token level enable detecting such anomalies in the text transcript associated with an audio sample. Moreover, embodiments described herein may consider the sequence of tokens of the text transcript. In contrast, image classifiers classify the image with a single classification outcome. Sequences are not applicable.

Influence functions estimate how the model's parameters and predictions would change if an individual training example were removed or slightly perturbed. By approximating the effect of each training instance on the trained model, influence functions make it possible to trace a prediction error or unusual model behavior back to the specific training points that caused it.

Influence functions are utilized by at least one embodiment for discovering mislabeled data. If a certain training sample—due to its label or its features—is heavily skewing the model's decision boundary or predictions, the influence function highlights that sample as having a disproportionately large effect. By identifying these influential samples, one or more actions may be automatically taken, as described herein. For example, the identified samples may be manually inspected to determine whether they were correctly labeled, and/or corrections may be made if necessary. Such targeted approach of identified specific samples which are likely anomalous may improve quality control, and/or help reduce the time and/or effort spent checking large datasets and/or may help ensures that the training data's integrity is maintained, ultimately leading to more robust model performance.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

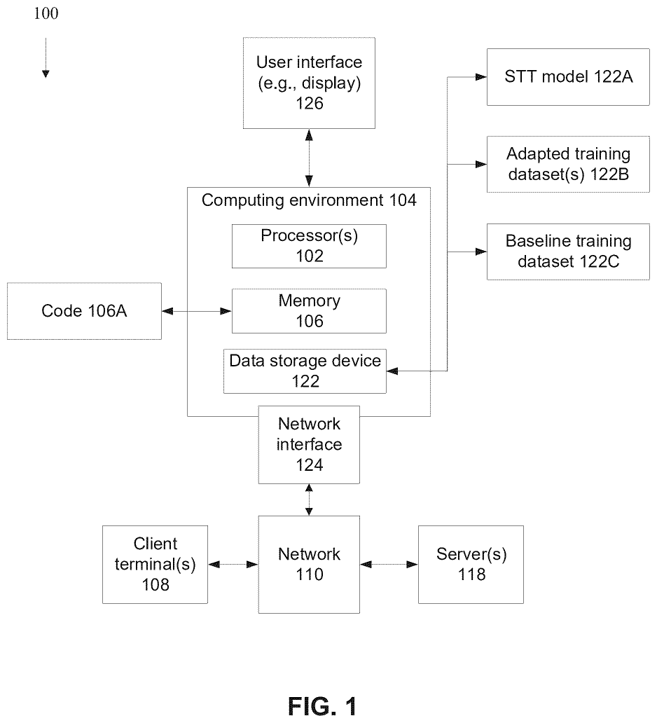

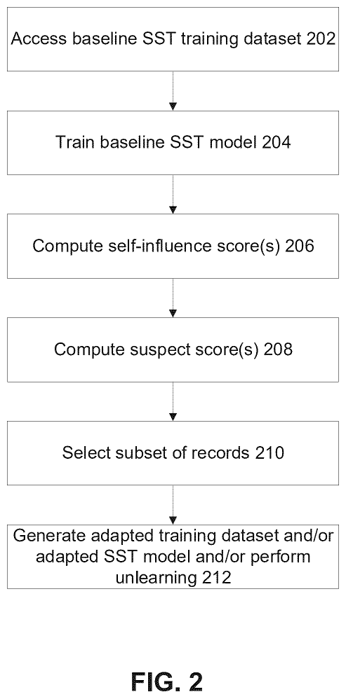

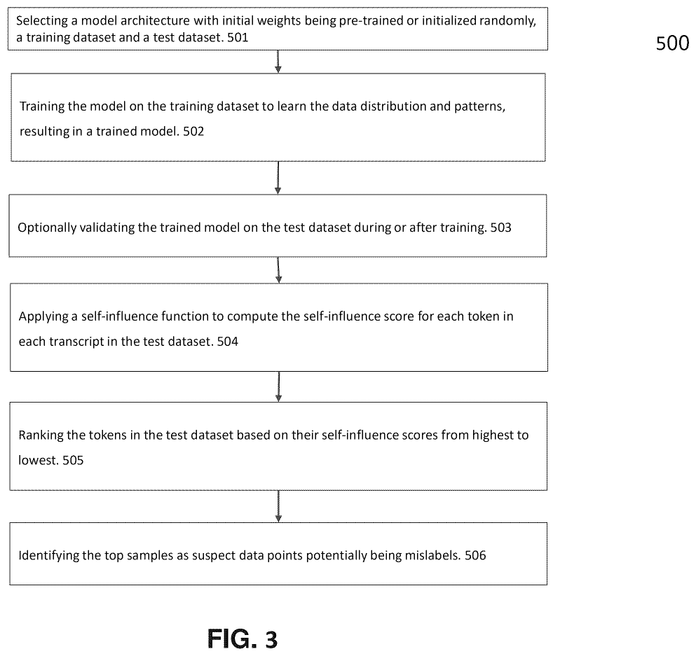

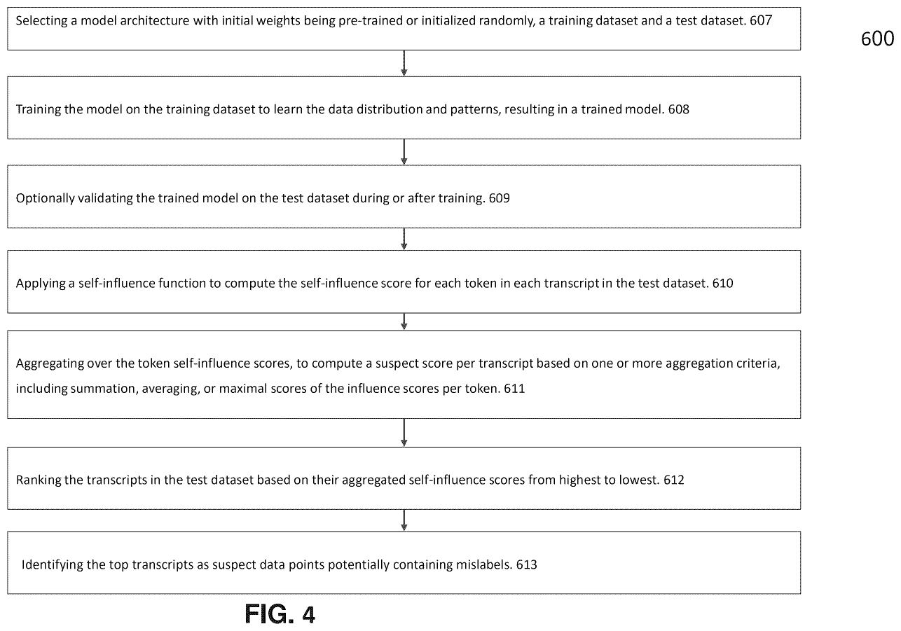

Reference is also made to FIG. 1, which is a block diagram of an exemplary system 100 for identifying anomalous text transcripts of audio samples, in accordance with some embodiments of the present invention. Reference is also made to FIG. 2, which is a flowchart 200 of an exemplary method for identifying anomalous text transcripts of audio samples, in accordance with some embodiments of the present invention. Reference is also made to FIG. 3, which is a flowchart 500 of another exemplary method for identifying potentially mislabeled audio samples, in accordance with some embodiments of the present invention. Reference is also made to FIG. 4, which is a flowchart 600 of yet another exemplary method for identifying potentially mislabeled audio samples, in accordance with some embodiments of the present invention.

As used herein, the term optimization—of the baseline training dataset—refers to identifying of anomalies in the baseline training dataset. The anomalies may refer to, for example, an error in the text transcript (i.e., in one or more tokens thereof) corresponding to an audio sample, a missing text transcript (or missing token(s)), and the like. The adapted training dataset may be created by removal of the anomalies and/or correction of the anomalies. Alternatively or additionally, the anomalies may be unlearned by the trained STT model.

Referring now back to FIG. 1, system 100 may implement the acts of the methods described herein, by processor(s) 102 of a computing environment 104 executing code instructions stored in a memory 106 (also referred to as a program store).

Computing environment 104 may analyze a baseline training dataset 122C for optimization thereof, optionally for creating an adapted training dataset 122B and/or computing environment 104 may implement one or more other features described herein.

Baseline training dataset 122C is arranged for training a STT model 122A, as described herein. Baseline training dataset 122C may be optimized, as described herein. An adapted training dataset 122B may be created by optimizing baseline training dataset 122C, as described herein.

Computing environment 104 may be implemented as, for example one or more and/or combination of: a group of connected devices, a client terminal, a server, a virtual server, a computing cloud and/or other cloud platform such as a virtual private cloud (VPC), a virtual machine, a desktop computer, a thin client, a network node, and/or a mobile device (e.g., a Smartphone, a Tablet computer, a laptop computer, a wearable computer, glasses computer, and a watch computer).

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for optimizing training datasets for training STT models. Services may be provided, for example, to one or more client terminals 108 over network 110, and/or to one or more server(s) 118 over network 110. Server(s) 118 may host one or more baseline training datasets 122C. Client terminals 108 may provide an indication of a location of baseline training dataset 122C. It is noted that baseline training datasets 122C may be stored and/or hosted in other locations. Services may be provided by computing environment 104 to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web site hosted by computing environment 104. In an example, a user may use client terminal 108 to request optimizing baseline training dataset 122C, for creation of adapted training dataset 122B to be used for training STT model 122A. In another example, baseline training dataset 122C may be hosted by server(s) 118, and computing environment 104 may optimize baseline training dataset 122C hosted by server(s) 118, and/or create adapted training dataset 122B and/or train STT model 122A.

In another exemplary architecture, computing environment 104 may be implemented as a standalone device (e.g., server, client terminal, smartphone) that includes locally stored code instructions 106A that implement one or more of the acts described herein, for locally optimizing baseline training dataset(s) 122C and/or creating adapted training dataset(s) 122B and/or training STT model 122A, and/or other features described herein. The locally stored code instructions 106A may be obtained from a server, for example, by downloading the code over the network, and/or loading the code from a portable storage device, such as by installing an app on a smartphone of a user.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described herein when executed by hardware processor(s) 102.

Computing environment 104 may include a data storage device 122 for storing data, for example, STT model 122A which is pre-trained on a different training dataset and/or to be trained and/or has been trained on adapted training dataset 122B, adapted training dataset(s) 122B created by optimizing baseline training dataset 122C, and/or baseline training 122C to be optimized. Data storage device 122 may be implemented as, for example, a memory, a local hard-drive, virtual storage, a removable storage unit, an optical disk, a storage device, and/or as a remote server and/or computing cloud (e.g., accessed using a network connection).

As used herein, the terms memory 106 and data storage device 122 may sometimes be interchanged. Use of one of the terms memory and data storage device is not meant to be necessarily limiting with respect to the location where code and/or data is stored. For example, data stored in data storage device 122 may be loaded into memory 106 for execution by processor 102. In another example, reference to data being stored in data storage device 122 may refer to the data being stored in memory 106.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 110 may be implemented as, for example, the internet, a local area network, a virtual network, a wireless network, a cellular network, a local bus, a point to point link (e.g., wired or via BlueTooth), and/or combinations of the aforementioned.

Computing environment 104 and/or client terminal(s) 108 include and/or are in communication with one or more user interfaces 126 designed for a user to provide input and/or view output. Exemplary user interfaces 126 include, for example, one or more of, a touchscreen, a display, gesture activation devices, a keyboard, a mouse, and voice activated software using speakers and microphone.

Referring now back to FIG. 2, at 202, a baseline STT training dataset is accessed (e.g., received, generated, selected). The baseline training dataset may reflect the data distribution that an STT model is to learn.

The baseline STT training dataset may include multiple audio samples, where each audio sample is labelled with a text transcript. The audio sample may be represented as, for example, a digital representation of an audio recording, and/or may be transformed into a spectrogram or similar time-frequency representation.

The text transcript includes multiple tokens. For example, the audio sample is a recording of a person speaking, and the label “Hello, how are you?”.

Each audio sample may be associated with multiple records; where the same audio sample is associated with a different token of a sequence of tokens of the text transcript associated with the audio sample.

In terms of mathematical representation, the STT training dataset is denoted Dₜᵣₐᵢₙ, which includes a dataset D of pairs (xᵢ, yᵢ)∈D, including an audio sample xᵢ (e.g., transformed into a spectrogram or similar time-frequency representation) and its matching transcript yᵢ (a sequence of text tokens).

The initial weights of the baseline STT model (i.e., prior to training on the baseline STT training dataset) may be computed by pre-training on a corpus of data, or the weights may be randomized.

The baseline STT model may be implemented using an architecture suitable for generating text transcripts of sequences of tokens in response to an audio input, for example, a neural network, such as a recurrent neural network (RNN), convolutional neural network (CNN), hybrid RNN-CNN, transformer, and the like. The architecture may be denoted M.

At 204, a baseline STT model is trained on the baseline STT training dataset.

The baseline STT model is trained to learn a data distribution and/or patterns of the baseline STT training dataset. A trained first STT model with a parameter vector is generated by training the baseline STT model on the baseline STT training dataset. In embodiments in which the trained STT model is implemented as a neural network, the parameter vector includes the weights of the neurons of the trained neural network. The parameter vector and previously generated tokens are provided as an input to the trained base STT model in association with the input audio sample. In response to the input, the trained baseline STT model generates a sequence of tokens, one by one. Each subsequent token is conditioned on the input audio sample and at least one previously generated token.

In terms of mathematical notation: The trained STT model estimates a conditional probability distribution denoted P(yᵢ|xᵢ; θ) over possible transcripts, where θ denotes the parameter vector. The trained baseline STT model denoted M(y_{i,j}|y_{i,j-1}; xᵢ; θ) indicates that the input is the parameter vector θ, the input audio denoted xᵢ (or its transformation into acoustic features) and the previously generated tokens denoted y_{i,j-1}={y_{i,1}, . . . , y_{i,j-1}}. The output is the token denoted y_{i,j} continuing the previously generated tokens, where i denotes the sample index out of the entire corpus, and j denotes the token index. The number of tokens in the vocabulary is denoted by V.

The initial weights of M(y_{i,j}|y_{i,j-1}; xᵢ; θ) may be pretrained on a corpus that may be unavailable to the end users, for example, kept within the systems of large corporations. Such pretrained parameter vector is denoted by θ₀. The baseline STT model, with parameters initialized to θ₀, is trained to capture the complex patterns in the training dataset.

Optionally, the baseline STT model is trained by minimizing the cross entropy loss function, denoted:

$${L}_{cross - entropy} ( {y}_{i , j} \vert {\underline{y}}_{i , j - 1} ; {x}_{i} ; θ ) = - log ( {M}_{t} ( {y}_{i , j} \vert {\underline{y}}_{i , j - 1} ; {x}_{i} ; θ ) )$$

where M(y_{i,j}|y_{i,j-1}; xᵢ; θ) denotes the output of the model M when the input is xᵢ and the weights are set as θ, with M(y_{i,j}|y_{i,j-1}; xᵢ; θ) being a vector of probabilities for each of the vocabulary tokens M(y_{i,j}|y_{i,j-1}; xᵢ; θ)∈[0, 1]^{V}.

The index t denotes the position of the specific output token y_{i,j} out of the overall V vocabulary tokens, and thus Mₜ(y_{i,j}|y_{i,j-1}; xᵢ; θ) is the t-th probability in the vector.

It is noted that the log function is selected due to the cross-entropy loss being used. However, the loss function is not limited only to this loss, and any other loss that actively pushes the model towards outputting the correct decision can be used. The output of the training is the parameter vector θ₁ which includes the knowledge of the distribution Dₜᵣₐᵢₙ. As discussed above, a user may not have access to the baseline training dataset Dₜᵣₐᵢₙ, but may have access to the baseline STT model trained on the inaccessible training dataset.

At 206, a self-influence score is computed for each token (i.e., token-level self-influence score) of each text transcript the baseline training dataset. The self-influence score is computed by a self-influence function that measures an alignment of each token with the patterns encoded in the parameter vector.

The self-influence score is computed per token since tokens are the smallest unit of data that can be identified as anomalous. To find anomalies in a sequence of tokens, for example mislabeled sentences, an aggregation over the mislabeled tokens is computed, as described below.

Optionally, a STT test dataset, denoted Dₜₑₛₜ, is accessed (e.g., received, generated, computed). The STT test dataset may be used, for example, when the baseline STT training dataset cannot be accessed, as discussed above. The STT test dataset may be used as a proxy for the baseline STT training dataset. The STT test dataset may include some of the data of the baseline STT training dataset, or may include entirely different data. A distribution of the STT test dataset is statistically similar to a distribution of the baseline STT training dataset. The statistically similar distribution enables using the STT test dataset as a proxy for the baseline STT training dataset. In terms of mathematical notation, Dₜₑₛₜ includes patterns similar to Dₜᵣₐᵢₙ (i.e., similar distribution), otherwise the parameter vector θ₁ is irrelevant. When the STT test dataset is used, the method described below is directed to the STT test dataset in place of the baseline STT training dataset discussed below. For example, the adapted STT training dataset discussed below is created from the STT test dataset rather than from the baseline STT training dataset. When the STT test dataset is not used, such as there is access to the baseline training dataset, the method described below is directed to the baseline STT training dataset. For example, the adapted STT training dataset discussed below is created from the baseline STT training dataset rather than from the STT test dataset. Reference below to the baseline STT training dataset and to the STT test dataset is meant to be not necessarily limiting, and the baseline STT training dataset and to the STT test dataset may be interchanged accordingly.

In terms of mathematical notation, the self-influence score may be computed for dataset Dₜₑₛₜ and the parameters θ₁. An influence measure denoted I(zₜᵣₐᵢₙ; zₜₑₛₜ; θ₁) may be selected. Exemplary influence measures include I_{up,loss} or the TraceIn function I_{TraceIn}, described below in additional detail. The influence measure indicates the influence, measured as the change in loss or another metric, of presenting to the model a sample zₜᵣₐᵢₙ on a sample zₜₑₛₜ. Consider for this case the self-influence function in which zₜᵣₐᵢₙ=zₜₑₛₜ, denoted by I(zₜₑₛₜ; zₜₑₛₜ; θ₁)≡I(zₜₑₛₜ; θ₁) in short. This measure is used to calculate the self-influence of each token in Dₜₑₛₜ, i.e., calculate I(y_{i,j}; θ₁) for i∈{1, . . . , |Dₜₑₛₜ|} and j∈{1, . . . , T} where T denotes the maximum sequence length (the maximum number of tokens in a sentence). This notation considers zₜₑₛₜ=(xᵢ, yᵢ) and in yᵢ is directed towards the loss of the token y_{i,j} in computing self-influence rather than on yᵢ as a whole.

Exemplary influence functions are now described. It is to be understood that other self influence functions may be selected.

A first exemplary influence function is implemented as an upweighting loss-based influence function that evaluates gradients of a loss function with respect to model parameters and incorporates a Hessian matrix (or other data structure) to estimate parameter sensitivity. The first exemplary influence function is described, for example, in Koh, P. W. and Liang, P., 2017 July. Understanding black-box predictions via influence functions. In International conference on machine learning (pp. 1885-1894). PMLR, incorporated herein by reference it its entirety. The influence function I_{up,loss}(zₜᵣₐᵢₙ; zₜₑₛₜ; θ) quantifies the change in the loss for a test point zₜₑₛₜ when a training point zₜᵣₐᵢₙ is upweighted by an infinitesimal amount, here θ denotes the vector of network parameters. The influence function is computed as:

$${I}_{up , loss} ( {z}_{train} ; {z}_{test} ; θ ) = - {∇}_{θ} {L ( {z}_{test} \vert θ )}^{T} {H}^{- 1} {∇}_{θ} L ( {z}_{train} \vert θ ) ,$$

Where ∇_{θ}L(z|θ) denotes the gradient of the loss with respect to the model parameters θ for the point z, H denotes the Hessian matrix of second derivatives of the loss with respect to θ, and the operations (⋅)^{T} and (⋅)⁻¹ denote the transpose and inverse operators, respectively.

A second exemplary influence function is implemented as a gradient-based trace function that computes sums of dot products of gradients of training and test data loss functions across multiple training checkpoints. The second exemplary influence function is the TracIn influence function, described by Pruthi, G., Liu, F., Kale, S. and Sundararajan, M., 2020. Estimating training data influence by tracing gradient descent. Advances in Neural Information Processing Systems, 33, pp. 19920-19930, incorporated herein by reference in its entirety, which described a method to estimate the influence of individual training examples on a model's predictions. TracIn operates by tracing how the loss on a specific test point changes during training whenever a particular training example is used. This is achieved by summing the dot products of the gradients of the loss with respect to the model's parameters for both the training and test examples, across various training checkpoints. Mathematically, for a training point zₜᵣₐᵢₙ and a test point zₜₑₛₜ, this is formulated as:

$${I}_{TraceIn} ( {z}_{train} ; {z}_{test} ; θ ) = {\sum }_{i = 1}^{K} {η}_{i} {∇}_{θ} L ( {z}_{train} \vert {θ}_{{k}_{i}} ) \cdot {∇}_{θ} L ( {z}_{test} \vert {θ}_{{k}_{i}} ) ,$$

where ηᵢ denotes the learning rate at checkpoint kᵢ and ∇_{θ}L(z|θₖ_{ᵢ}) denotes the gradient of the loss function with respect to model parameters θ at checkpoint kᵢ for the sample z.

The aforementioned approach provides a practical and scalable means to understand the impact of training data on model behavior, applicable to any model trained using stochastic gradient descent or its variants.

At 208, a suspect score per text transcript (i.e., transcript-level suspect score) may be computed. The suspect score is computed by aggregating over multiple self-influence scores computed for multiple tokens of the text transcript corresponding to the audio sample.

Exemplary approaches for aggregating over the token self-influence scores, to compute the suspect score per transcript, include:
Summation: Compute the transcript-level score by summing the self-influence scores of all tokens within the transcript. This approach highlights transcripts where multiple tokens have high individual self-influence scores.
Averaging: Calculate the average of the self-influence scores across all tokens in the transcript. This approach provides a normalized measure of the overall self-influence of the transcript, accounting for varying transcript lengths.
Maximal Score: Select the maximum self-influence score among the self-influence scores computed for the tokens in the transcript. This approach focuses on the most problematic token within each transcript, potentially identifying highly anomalous labels.

At 210, a subset of records (i.e., audio samples and corresponding text transcripts) of the baseline STT training dataset (or the STT test dataset) having self-influence scores meeting a requirement indicating audio samples that are likely mislabeled, is identified.

The records (e.g., audio samples and/or text transcripts and/or individual tokens) of the baseline STT training dataset (or the STT test dataset) may be ranked according to corresponding self-influence scores from highest to lowest, or from lowest to highest, depending on whether an increasingly higher self-influence score indicates that the corresponding audio sample has an increasingly higher probability of being mislabeled or a decreasing lower probability of being mislabeled.

Exemplary requirements include: a fixed absolute number of audio samples, a relative proportion of a number of the audio samples in the STT training dataset, and a knee-point analysis identifying an inflection point in a plot of self-influence scores arranged in descending order.

In terms of mathematical representation, individual tokens may be ranked {y_{i,j}} from highest to lowest self-influence scores. It is noted that even when the model parameterized by θ₁ was not trained on Dₜₑₛₜ, the self-influence function I(zₜₑₛₜ; θ₁) does not require zₜₑₛₜ to be part of Dₜᵣₐᵢₙ. Instead, it can be used to evaluate the alignment (or misalignment) of zₜₑₛₜ with the patterns encoded in the model parameters θ₁. It is noted that the caveat here is that there are indeed shared patterns between Dₜᵣₐᵢₙ and Dₜₑₛₜ for the influence score to be meaningful as an anomaly detector.

As discussed above, the influence function estimates how individual training instances (or tokens within a sample) affect the model's parameters and predictions. When a sample strongly “influences” itself, it may be an indicator that the model is forced to contort its decision boundaries or representational space to accommodate that particular example. In the context of self-influence, if a sample exerts a disproportionately large influence on itself, it might suggest that the model struggled to fit that sample, possibly because the label does not align well with the features.

Mislabeling is one key reason why certain samples might stand out in this way (though other reasons exist, such as being an outlier). By ranking samples based on their self-influence scores, samples that have affected their own decision boundaries the most may be identified. These high-influence samples are prime suspects for label inaccuracies, serving as a starting point for human inspection and correction (or removal, or unlearning), ultimately improving the overall quality and consistency of the dataset which results in an improved trained STT model.

The K top tokens may be identified as suspects for inspection or automatic removal from the dataset Dₜₑₛₜ or for being unlearned. It is noted that K can be chosen by different approaches, for example:
Absolute Count: Select a fixed number K of samples (e.g., 100) based on available resources and manual inspection capacity.
Relative Proportion: Select K as a percentage of the dataset size (e.g., top 5% of the samples), which scales with the size of Dₜₑₛₜ.
Knee Point (Elbow) Method: Plot the self-influence scores in descending order and identify a “knee point” in the curve—an inflection where including additional samples yields rapidly diminishing returns. Set K to the index corresponding to this knee point.

After calculating the suspect scores for each transcript, the transcripts may be ranked, and the subset may include the top K suspect transcripts, by adapting the approach described above for tokens.

At 212, one or more features may be implemented in response to identification of the subset of audio samples and corresponding transcripts from the baseline STT training dataset or the STT test dataset.

Exemplary features include:
Correcting the text transcripts for each audio sample of the subset, to generate an adapted STT training dataset. The adapted STT training dataset may be provided for training a second STT model on the adapted STT training dataset. The second STT model may be trained on the adapted STT training dataset.
Removing the text transcripts and corresponding audio samples (i.e., records) of the identified subset from the baseline STT training dataset or the STT test dataset, to generate an adapted STT training dataset. The adapted STT training dataset may be provided for training a second STT model on the adapted STT training dataset. The second STT model may be trained on the adapted STT training dataset. The second STT model is predicted to have better performance (e.g., higher accuracy) than the baseline STT model.
Triggering an unlearning process for unlearning the subset from the trained first STT model. Exemplary unlearning processes are described, for example, with respect to “UNLEARNING TEXT DATA FROM TRAINED LANGUAGE MODELS” U.S. patent application Ser. No. 19/278,971, filed on Jul. 24, 2025, having at least one Inventor in common with the present disclosure, and incorporated herein by reference in its entirety.

Optionally, a graphical user interface (GUI) is generated and/or presented on a display. The GUI may presents the text transcripts of the identified subset, and a visual element associated with each text transcript. The visual element may designed to be interacted with, for example, a button, a link, and the like. The GUI may generated instructions to play the audio sample corresponding to the text transcript over a speaker in response to interaction with the visual element. The GUI may include a mechanism for enabling a user to manually adapt each text transcript of the subset after hearing the corresponding play of the audio sample over the speaker. For example, the text transcript is presented in an editable window that is designed to enable a user to manually edit the text transcript. The edited text transcripts may be saved in associated with the audio samples. An adapted STT training dataset may be created by replacing the identified subset with the edited subset. The adapted STT training dataset may be provided for training a second STT model on the adapted STT training dataset. The second STT model may be trained on the adapted STT training dataset.

Referring now back to FIG. 3, at 501, a model architecture with initial weights that are pre-trained or initialized randomly, a training dataset, and optionally a test dataset, are selected.

At 502, the model is trained on the training dataset to learn the data distribution and patterns, generating a trained model.

At 503, the trained model is optionally validated on the test data, during and/or after training.

At 504, a self-influence function is applied to compute the self-influence score for each token in each transcript in the test dataset.

At 505, tokens are ranked in the test dataset based on their self-influence scores from highest to lowest.

At 506, the top samples are identified as suspect data points potentially being mislabels.

Referring now back to FIG. 4, at 607, a model architecture with initial weights that are pre-trained or initialized randomly, a training dataset, and optionally a test dataset, are selected.

At 608, the model is trained on the training dataset to learn the data distribution and patterns, generating a trained model.

At 609, the trained model is optionally validated on the test data, during and/or after training.

At 610, a self-influence function is applied to compute the self-influence score for each token in each transcript in the test dataset.

At 611, a suspect score is computed per transcript by aggregating over the token self-influence scores. The aggregation is computed based on one or more aggregation criteria, for example, summation, averaging, or maximal scores of the influence scores per token.

At 612, the transcripts are ranked in the test dataset based on their aggregated self-influence scores from highest to lowest.

At 613, the top transcripts are identified as suspect data points potentially containing mislabels.

Additional exemplary embodiments are now described.

According to an aspect of some embodiments of the present invention there is provided a method for identifying mislabeled data in a STT dataset, comprising: selecting a model architecture M(y_{i,j}|y_{i,j-1}; xᵢ; θ) with initial weights being pretrained or initialized randomly and denoted by θ₀, a training dataset Dₜᵣₐᵢₙ, and a test dataset Dₜₑₛₜ, training the model on Dₜᵣₐᵢₙ to learn the data distribution and patterns, resulting in a trained model with parameter vector θ₁, optionally validating the trained model on Dₜₑₛₜ during and/or after training, applying a self-influence function I to compute the self-influence score I(y_{i,j}; θ₁) for each token in each transcript yᵢ where (xᵢ, yᵢ)∈Dₜₑₛₜ, where the self-influence function measures the alignment of each sample with the patterns encoded in θ₁, ranking the samples in Dₜₑₛₜ based on their self-influence scores from highest to lowest, and identifying the top K samples as suspect data points potentially containing mislabels.

According to some embodiments of the invention, the influence function/is selected from a group comprising: (i) an upweighting loss-based influence function I_{up,loss}, which evaluates the gradient of the loss with respect to model parameters and incorporates a Hessian matrix to estimate parameter sensitivity, and (ii) a gradient-based trace function I_{TraceIn}, which sums the dot products of gradients of training and test data loss functions across multiple training checkpoints.

According to some embodiments of the invention, the suspects considered for ranking and identification are individual tokens. In such embodiments directed towards individual tokens, the method further comprises: calculating the self-influence scores for each token in each transcript in Dₜₑₛₜ, defining a ranking mechanism for identifying suspect tokens, and outputting the top K tokens based on one or more selection criteria, including absolute count, relative proportion, or a knee-point analysis of the influence score distribution.

According to some embodiments of the invention, the suspects considered for ranking and identification are full transcripts. In such embodiments directed towards full transcripts, the method further comprises: calculating the self-influence scores for each token in each transcript in Dₜₑₛₜ, aggregating over the token self-influence scores, to compute a suspect score per transcript based on one or more aggregation criteria, including summation, averaging, or maximal scores of the influence scores per token, defining a ranking mechanism for identifying suspect transcripts, and outputting the top K transcripts based on one or more selection criteria, including absolute count, relative proportion, or a knee-point analysis of the influence score distribution.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant STT training datasets and STT models will be developed and the scope of the terms STT training dataset and STT model are intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer-implemented method for generating an adapted speech-to-text (STT) training dataset for training a STT model, comprising:
accessing a baseline STT training dataset comprising a plurality of audio samples, each audio sample labelled with a text transcript;
training a first STT model on the baseline STT training dataset to learn a data distribution and patterns of the baseline STT training dataset to generate a trained first STT model with a parameter vector;
computing, for each token in each text transcript of the baseline training dataset, a self-influence score by a self-influence function that measures an alignment of each token with the patterns encoded in the parameter vector;
selecting a subset of audio samples of the baseline STT training dataset having self-influence scores meeting a requirement indicating audio samples that are likely mislabeled;
removing the subset of audio samples and corresponding transcripts from the baseline STT training dataset, or correcting the text transcripts for each audio sample of the subset, to generate an adapted STT training dataset; and
providing the adapted STT training dataset for training a second STT model on the adapted STT training dataset or for unlearning the subset from the trained first STT model.

2. The computer-implemented method of claim 1, further comprising training the second STT model on the adapted STT training dataset.

3. The computer-implemented method of claim 1, further comprising triggering a process for unlearning the subset of audio samples by the first trained STT model.

4. The computer-implemented method of claim 1, further comprising: generating a graphical user interface (GUI) presented on a display, the GUI presenting each text transcript of the subset and a visual element associated with each text transcript, the GUI configured to play the audio sample corresponding to the text transcript over a speaker in response to interaction with the visual element, the GUI configured for enabling a user to manually adapt each text transcript of the subset.

5. The computer-implemented method of claim 1, wherein the selecting is based on self-influence scores computed for individual tokens within the text transcripts, wherein the subset of audio samples selected from the baseline STT training dataset correspond to individual tokens of the plurality of text transcripts.

6. The computer-implemented method of claim 1, further comprising computing a suspect score per text transcript by aggregating over a plurality of self-influence scores computed for a plurality of tokens of the text transcript corresponding to the audio sample,
wherein the subset of audio samples is selected from the baseline STT training dataset based on the suspect scores that are derived from the self-influence scores of corresponding text transcripts of the plurality of tokens.

7. The computer-implemented method of claim 6, wherein the aggregating is selected from a group consisting of: summation of the plurality of self-influence scores over the plurality of tokens of the text transcript, averaging of the plurality of self-influence scores over the plurality of tokens of the text transcript, and selecting a maximum self-influence score among the plurality of self-influence scores computed for the plurality of tokens of the text transcript.

8. The computer-implemented method of claim 1, further comprising ranking the audio samples of the baseline STT training dataset according to corresponding self-influence scores from highest to lowest, and the requirement denotes a predefined number of highest or lowest ranked audio samples likely being mislabeled.

9. The computer-implemented method of claim 1, wherein the trained first STT model generates a sequence of tokens one by one, with each subsequent token being conditioned on an input audio sample and at least one previously generated token, wherein the parameter vector and previously generated tokens are provided as an input to the trained first STT model in association with the input audio sample.

10. The computer-implemented method of claim 1, wherein initial weights of the first STT model prior to training on the baseline STT training dataset are computed by pre-training on a corpus of data or randomized.

11. The computer-implemented method of claim 1, wherein the first STT model and the second STT model are implemented as neural networks, wherein the parameter vector includes the weights of the neurons of the trained neural network.

12. The computer-implemented method of claim 1, wherein the self-influence function is selected from the group consisting of:
an upweighting loss-based influence function that evaluates gradients of a loss function with respect to model parameters and incorporates a Hessian matrix to estimate parameter sensitivity, and
a TracIn influence function comprising a gradient-based trace function that computes sums of dot products of gradients of training and test data loss functions across a plurality of training checkpoints.

13. The computer-implemented method of claim 1, wherein the requirement is selected from a group consisting of: a fixed absolute number of audio samples, a relative proportion of a number of the plurality of audio samples in the baseline STT training dataset, and a knee-point analysis identifying an inflection point in a plot of self-influence scores arranged in descending order.

14. The computer-implemented method of claim 1, wherein the self-influence score is computed for a STT test dataset different from the baseline STT training dataset, wherein a distribution of the STT test dataset is statistically similar to a distribution of the baseline STT training dataset, wherein the subset is selected from the STT test dataset, and wherein the adapted STT training dataset is created from the STT test dataset serving as a second STT training dataset.

15. A computer-implemented method for generating an adapted speech-to-text (STT) training dataset for training a STT model, comprising:
accessing a baseline STT training dataset comprising a plurality of audio samples, each audio sample labelled with a text transcript;
training a first STT model on the baseline STT training dataset to learn a data distribution and patterns of the baseline STT training dataset to generate a trained first STT model with a parameter vector;
computing, for each token in each text transcript of the baseline training dataset, a self-influence score by a self-influence function that measures an alignment of each token with the patterns encoded in the parameter vector;
computing a suspect score per text transcript by aggregating over a plurality of self-influence scores computed for a plurality of tokens of an audio sample corresponding to the text transcript;
selecting a subset of audio samples of the baseline STT training dataset having suspect scores meeting a requirement indicating audio samples that are likely mislabeled;
removing the subset of audio samples and corresponding transcripts from the baseline STT training dataset, or correcting the text transcripts for each audio sample of the subset, to generate an adapted STT training dataset; and
providing the adapted STT training dataset for training a second STT model on the adapted STT training dataset or for unlearning the subset from the trained first STT model.

16. A computer-implemented method for generating an adapted speech-to-text (STT) training dataset for training a STT model, comprising:
accessing a baseline STT training dataset comprising a plurality of audio samples, each audio sample labelled with a text transcript;
training a first STT model on the baseline STT training dataset to learn a data distribution and patterns of the baseline STT training dataset to generate a trained first STT model with a parameter vector;
computing, for each token in each text transcript of the baseline training dataset, a self-influence score by a self-influence function that measures an alignment of each token with the patterns encoded in the parameter vector;
selecting a subset of audio samples of the baseline STT training dataset having self-influence scores meeting a requirement indicating audio samples that are likely mislabeled;
unlearning the subset of audio samples and corresponding transcripts from the trained first STT model.
